(19) United States
(12) Patent Application Publication
(10) Pub. No.: US 2024/0376281 A1
(43) Pub. Date: Nov. 14, 2024

(54) POLYURETHANE SPONGE STEPWISE DECOMPRESSION PRODUCTION SYSTEM USING LIQUID CARBON DIOXIDE AS A FOAMING AGENT

(71) Applicants: Shanghai Songtao Automation Equipment Co., Ltd., Shanghai (CN); Shanghai Yingqian Machinery Equipment Co., Ltd., Shanghai (CN)

(72) Inventors: Chengchun Yang, Shanghai (CN); Jian Chen, Shanghai (CN); Yuhong Liao, Shanghai (CN); Fenglin Tang, Shanghai (CN); Yongquan Mei, Shanghai (CN); Lingyan Mei, Shanghai (CN)

(73) Assignees: Shanghai Songtao Automation Equipment Co., Ltd., Shanghai (CN); Shanghai Yingqian Machinery Equipment Co., Ltd., Shanghai (CN)

(21) Appl. No.: 18/630,284

(22) Filed: Apr. 9, 2024

(30) Foreign Application Priority Data
May 9, 2023 (CN) 202310520598.6

(51) Int. Cl. C08J 9/12

(52) U.S. Cl. CPC C08J 9/122; C08J 2201/024; C08J 2201/034; C08J 2203/06; C08J 2203/08; C08J 2375/04

(57) ABSTRACT

In the polyurethane sponge stepwise decompression production system, liquid carbon dioxide and other materials are injected into a stirring device at high pressure to obtain a mixture. The mixture is decompressed through the outlet of the stirring device to slightly higher than the saturated vapor pressure of liquid carbon dioxide and fed into a pouring system. When sprayed from the pouring system, it is quickly reduced to atmospheric pressure and foams into a polyurethane sponge. Carbon dioxide remains liquid during the measurement, transportation and mixing to prevent premature vaporization which affects the quality of polyurethane sponges. A filter and a pouring mold are equipped. The mixture is filtered and cut by the filter to form uniform and fine carbon dioxide foam nuclei, which is then sprayed out through the pouring mold and falls onto a conveyor to continuously foam and harden into a polyurethane sponge foam with uniform porosity.

### FIELD OF THE DISCLOSURE

The application relates to the technical field of polyurethane sponge production, and particularly relates to a polyurethane sponge stepwise decompression production system using liquid carbon dioxide as a foaming agent.

### BACKGROUND

In the continuous production process of bulk polyurethane sponge, the most used method is using at least one component (especially polyol compounds, such as polyether) containing hydroxyl (—OH), and mixing it with an auxiliary physical foaming agent (commonly Dichloromethane or MC), a nucleating gas (dry air or nitrogen), and other additives, and further mixing it with components (especially isocyanates, such as TDI, MDI, etc.) containing isocyanate (—CON). Then a chemical foaming agent (water) and a catalyst (tin) are injected into the mixture, and after high-speed stirring, the final mixture is sent to a continuously running conveyor belt. The final mixture undergoes a chemical reaction, one of the products of which is gaseous carbon dioxide, and the reaction simultaneously releases a large amount of heat. When heated, MC rapidly vaporizes and expands. The main product of the mixture reaction rapidly expands to form polyurethane foam under the combined action of nucleation bubbles, MC bubbles and carbon dioxide bubbles produced by the reaction. To produce high-quality polyurethane foam, it is necessary to control the foaming process to make the cells of the polyurethane foam uniform and fine. The conventional methods achieve this effect by increasing the amount of catalyst to shorten the nucleation time, by adjusting the mixing speed to promote gas dispersion, by adjusting the mixing head pressure to control the gas evaporation rate, and by increasing the nucleate agent to increase the amount of nucleation centers.

Because methylene chloride (MC) is harmful to the environment and human health, it is listed as a controlled substance and its use is restrict by countries around the world. To solve this problem, technical experts from various countries around the world have explored the use of liquid carbon dioxide to replace methylene chloride for foaming. Carbon dioxide itself is colorless, odorless, non-toxic, and harmless. Foaming using liquid carbon dioxide is stable and flame retardant, and has high foaming efficiency, lower costs, reasonable cell structures and other excellent characteristics.

However, since carbon dioxide at room temperature is a gas, it is not suitable in the known foaming processes to use liquid carbon dioxide to produce high-quality polyurethane. Therefore, there is an urgent need of a production system for producing high-quality polyurethane sponges, that can complete the foam nucleation process while maintaining the temperature and pressure of liquid carbon dioxide.

### SUMMARY OF THE INVENTION

In view of the above technical issues, the purpose of this application is to provide a polyurethane sponge stepwise decompression production system using liquid carbon dioxide as a foaming agent, using liquid carbon dioxide to replace toxic methylene chloride (MC) as the physical foaming agent, and completing the foam nucleation process under the temperature and pressure conditions of maintaining a liquid state of carbon dioxide to produce polyurethane foam with uniform cells.

To achieve the purpose mentioned above, the present application provides the following technical solutions.

A polyurethane sponge stepwise decompression production system using liquid carbon dioxide as a foaming agent, comprising a supply system, a stirring device, and a pouring system; wherein, the supply system includes a liquid carbon dioxide high-pressure supply unit, and an outlet of the liquid carbon dioxide high-pressure supply unit is connected to a feed port of the stirring device, and the stirring device is used to uniformly mix liquid carbon dioxide and other raw materials under high pressure to obtain a mixture; and, an outlet of the stirring device is connected to the pouring system, whereby the mixture is decompressed through the outlet of the stirring device to a pressure slightly higher than a saturated vapor pressure of liquid carbon dioxide and transported to the pouring system, and the mixture is sprayed from the pouring system, whereby the mixture is reduced to an atmospheric pressure and foams into a polyurethane sponge.

In some embodiments, the pouring system includes a pouring mold, and the pouring mold includes a discharge passage, wherein the discharge passage is provided with protruding structures, and the protruding structures are used to facilitate a turbulence of the mixture and forming of bubbles when sprayed through the discharge passage.

In some embodiments, a filter is further comprised, which is provided on a pipeline between the outlet of the stirring device and the pouring system, and used for filtering and cutting the mixture to generate microbubbles.

In some embodiments, a pressure regulating device is further comprised, wherein the pressure regulating device includes a first pressure regulating valve and a second pressure regulating valve, and the first pressure regulating valve is arranged at the pipeline between the outlet of the stirring device and the filter, to maintain the mixture at a pressure close to or slightly above the partial pressure of the carbon dioxide to slow down the vaporization of the carbon dioxide; and, the second pressure regulating valve is provided at the pipeline between the filter and the pouring system, to reduce the pressure of the mixture to accelerate the vaporization of the carbon dioxide.

In some embodiments, the supply system further includes a polyol high-pressure supply unit, an additive high-pressure supply unit, an isocyanate high-pressure supply unit, a chemical reagent high-pressure supply unit, an auxiliary high-pressure supply unit, and a nucleation gas supply unit, that are respectively connected to feed ports of the stirring device.

In some embodiments, an outlet of the polyol high-pressure supply unit and the outlet of the liquid carbon dioxide high-pressure supply unit are liquidly connected to a static mixer, and the static mixer is used to uniformly mix polyol and the liquid carbon dioxide to form an initial mixture; and, an outlet of the static mixer and an outlet of the additive high-pressure supply unit are brought together at a first high-pressure manifold to uniformly mix additives and the initial mixture to form an intermediate mixture, and an outlet of the first high-pressure manifold is connected to the feed port of the stirring device; and, an outlet of the nucleation gas supply unit is connected to the outlet of the first high-pressure manifold, to inject nucleation gas into the intermediate mixture before entering the stirring device.

In some embodiments, the pouring mold includes a feed pipe, a feed port left damping plate, a feed port right damping plate, a discharge port left damping plate, and a discharge port right damping plate; and, the feed port left damping plate is provided with a feed channel, and the feed port right damping plate is provided with a storage channel, and the feed channel and the storage channel together constitute a storage space, and a first discharge passage is provided below the storage space; and, the discharge port left damping plate is arranged below the feed port left damping plate, and the discharge port right damping plate is arranged below the feed port right damping plate, and a tapered second discharge passage is provided between the discharge port left damping plate and the discharge port right damping plate, and the tapered second discharge passage is provided with the protruding structures, and the tapered second discharge passage is connected to the first discharge passage.

In some embodiments, the protruding structures constitute a corrugated structure, and the discharge port left damping plate is provided with a first corrugated surface, and the discharge port right damping plate is provided with a second corrugated surface, whereby the first corrugated surface and the second corrugated surface cooperate to constitute the corrugated structure.

In some embodiments, the filter includes a filter housing and a filter screen, wherein the filter housing has a inlet section, an expanding section, a straight section, a contracting section and a outlet section, and a cross-sectional area of the inlet section has a same size as a cross-sectional area of the outlet section and is smaller than a cross-sectional area of the straight line section, and central axes of the inlet section, the expanding section, the straight section, the contracting section and the outlet section are on a same straight line; and, the filter screen has a U-shaped longitudinal section and is detachably installed inside the filter housing, and a set gap is arranged between an outer wall of the filter screen and an inner wall of the filter housing, and constitutes a filter flow cavity.

In some embodiments, the liquid carbon dioxide high-pressure supply unit, the polyol high-pressure supply unit, the additive high-pressure supply unit, the isocyanate high-pressure supply unit, the chemical reagent high-pressure supply unit and the auxiliary high-pressure supply unit are respectively provided with feed storage tanks and self-circulating exhaust pipelines respectively connected to each of the feed storage tanks, used to discharge gas in pipelines for accurate measurement of dosages; and, the supply system further includes metering devices and measuring devices respectively provided on each of the self-circulating exhaust pipelines.

Compared with the existing technologies, the polyurethane sponge stepwise decompression production system using liquid carbon dioxide as a foaming agent provided by the present application has the following beneficial effects.
1. In the polyurethane sponge stepwise decompression production system provided by the present application, liquid carbon dioxide and other raw materials are injected into the stirring device at high pressure to obtain a mixture. The mixture is decompressed through the outlet of the stirring device to a pressure level slightly higher than the pressure of the saturated vapor of the liquid carbon dioxide, and sent to the pouring system. When the mixture is sprayed from the pouring system, its pressure is quickly reduced to the atmospheric pressure. It then falls onto the conveyor and continues to foam and harden to form a polyurethane sponge foam. The carbon dioxide is always maintained in a liquid state during the process of metering, transporting, and mixing, to prevent the liquid carbon dioxide from evaporating prematurely and from affecting the quality of the polyurethane sponge.
2. The pouring system provided by the present application includes a filter and a pouring mold. The mixture is first cut by the filter to produce uniform and fine carbon dioxide bubble nuclei, and is then sprayed from the discharge passage of the pouring mold. The discharge passage of the pouring mold is provided with a corrugated structure. When the mixture is rapidly ejected from the discharge passage, the sharp change in the cross-section results in the formation of a turbulent flow. When the mixture is ejected, its pressure is sharply reduced to an atmospheric pressure. Carbon dioxide quickly evaporates from the mixture and agglomerates to the previously formed small bubble nuclei. Uniform cells are formed and filled between the solids generated by the reaction.
3. The filter provided by the present application first filters the mixture to avoid impurities in the poured mixture, and the filter screen has a U-shaped longitudinal section and is detachably installed in the filter housing to provide a larger filtering area. It is more efficient in filtering impurities and is easy to replace and clean, and is durable.
4. The present application uses liquid carbon dioxide as a physical foaming agent instead of toxic methylene chloride (MC). Liquid carbon dioxide is low cost, non-toxic, widely available, and reduces the production cost and environmental pollution of polyurethane sponges.

### BRIEF DESCRIPTION OF THE DRAWINGS

In the following preferred embodiments, the above-mentioned characteristics, technical features, advantages, and implementation methods of the present application will be further described in a clear and understandable manner with reference to the accompanying drawings.

FIG. 1 is a schematic diagram of the overall structure of the stepwise decompression production system for polyurethane sponges provided by the present application.

FIG. 2 is a schematic structural diagram of the pouring system provided by the present application.

FIG. 3 is a schematic structural diagram of the filter provided by the present application.

FIG. 4 is a schematic structural diagram of the pouring mold provided by the present application.

FIG. 5 is a partial enlarged view of the region X marked in FIG. 4.

Explanation of reference numbers: 1—Polyol high-pressure supply unit; 2—Second high-pressure manifold; 3—Liquid carbon dioxide high-pressure supply unit; 4—Static mixer; 5—Additive high-pressure supply unit; 6—First high-pressure manifold; 7—Nucleation gas supply unit; 8—Chemical reagent high-pressure supply unit; 9—Auxiliary high-pressure supply unit; 10—Stirring device; 11—Additional raw material high-pressure supply unit; 12—Isocyanate high-pressure supply unit; 13—First pressure regulating valve; 14—First filter; 15—Second pressure regulating valve; 16—First pouring mold; 17—Second filter; 18—Third pressure regulating valve; 19—Second pouring mold; 20—Filter housing; 21—Filter screen; 22—Feed pipe; 23—Feed port left damping plate; 24—Feed port right damping plate; 25—Discharge port left damping plate; 26—Discharge port right damping plate.

### DESCRIPTION OF THE ILLUSTRATED EMBODIMENTS

To illustrate the embodiments of the present application or the technical solutions in the prior art more clearly, the specific embodiments of the present application will be described below with reference to the accompanying drawings. Obviously, the accompanying drawings in the following description are only some embodiments of the present application, and for those of ordinary skill in the art, other drawings can also be obtained from these drawings without creative efforts, to obtain other embodiments.

To keep the drawings concise, only the parts related to the application are schematically shown in each FIG., and they do not represent the actual structure of the products. In addition, to make the drawings concise and easy to understand, in some FIG.s, only one of the components having the same structure or function is schematically shown, or only one of them is marked. As used herein, “one” not only means “only one”, but also “more than one”.

It should also be further understood that, as used in this specification and the claims, the term “and/or” refers to and including any and all possible combinations of one or more of the associated listed items.

In this description, it should be noted that, unless otherwise expressly specified and limited, the terms “installed”, “connected” and “connecting” should be understood in a broad sense. For example, it may be a fixed connection or a detachable connection, or it can be connected into a whole piece; or it can be a mechanical connection or an electrical connection; or it can be directly connected or indirectly connected through an intermediate medium, and it can be internal communication between two components. For those of ordinary skill in the art, the specific meanings of the above terms in the present application can be understood in specific situations.

In addition, in the description of the present application, the terms “first”, “second” and the like are only used to distinguish the features, and should not be understood as indicating or implying relative importance.

### Embodiment 1

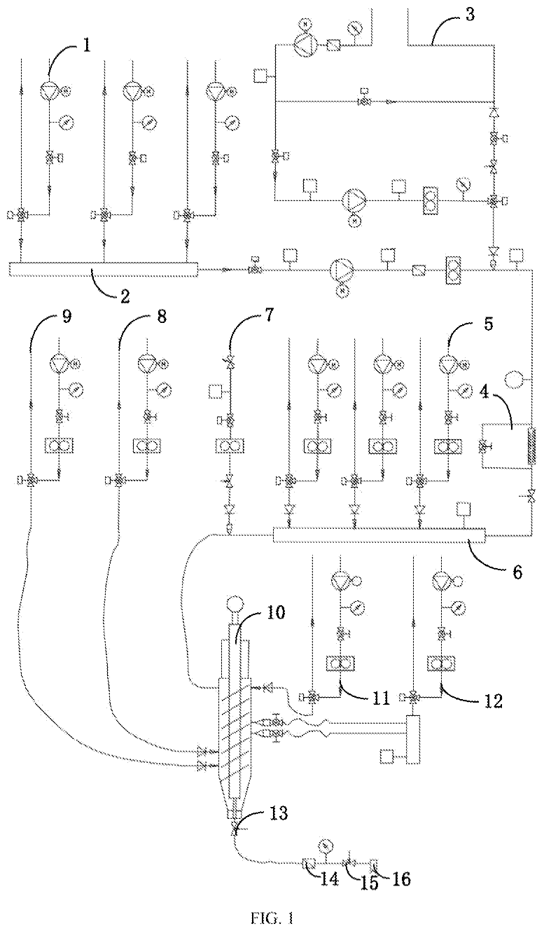

As shown in FIG. 1, the polyurethane sponge stepwise decompression production system using liquid carbon dioxide as a foaming agent provided by the present application includes a supply system, a stirring device 10 and a pouring system. The supply system includes a liquid carbon dioxide high-pressure supply unit 3. The outlet of the liquid carbon dioxide high-pressure supply unit 3 is connected to a feed port of the stirring device 10. The stirring device 10 is used to evenly stir the liquid carbon dioxide and other raw materials under high pressure to obtain a mixture. The outlet of the stirring device 10 is connected to the pouring system, and the mixture passing through the outlet of the stirring device 10 is depressurized to a pressure slightly higher than the saturated vapor pressure of liquid carbon dioxide and sent to the pouring system. After the mixture is sprayed from the pouring system, its pressure is reduced to an atmospheric pressure, and the carbon dioxide quickly evaporates from the mixture, and the mixture quickly grows up to form a polyurethane sponge.

In this embodiment, the supply system also includes a polyol high-pressure supply unit 1, an additive high-pressure supply unit 5, an isocyanate high-pressure supply unit 12, a chemical reagent high-pressure supply unit 8, an auxiliary high-pressure supply unit 9, and a nucleation gas supply unit 7, which are respectively connected to feed ports of the stirring device 10. The above-mentioned supply units in turn introduce the raw materials into the stirring device 10 to be evenly stirred together with liquid carbon dioxide to obtain a mixture.

### Embodiment 2

Based on Embodiment 1, the pouring system includes a first pouring mold 16. The first pouring mold 16 is configured with a discharge passage. The discharge passage is provided with protruding structures. When the mixture is sprayed through the discharge passage, it passes through the protruding structures. Due to sharp changes in the cross-section, collision and turbulence are generated, which help to generate bubbles and improve the foaming effect.

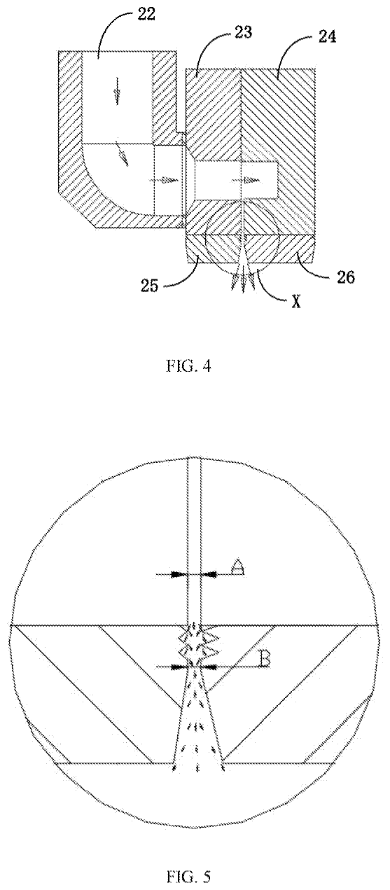

As shown in FIG. 1, also referring to FIG. 4 and FIG. 5, this embodiment provides a preferred implementation of a pouring mold. The first pouring mold 16 includes a feed pipe 22, a feed port left damping plate 23, a feed port right damping plate 24, a discharge port left damping plate 25, and a discharge port right damping plate 26. The feed port left damping plate 23 is provided with a feed channel, and the feed port right damping plate 24 is provided with a storage channel. The feed channel and the storage channel together constitute a storage space, and a first part A of the discharge passage is provided below the storage space.

The discharge port left damping plate 25 is arranged below the feed port left damping plate 23, and the discharge port right damping plate 26 is disposed below the feed port right damping plate 24. Between the discharge port left damping plate 25 and the discharge port right damping plate 26, a tapered second part B of the discharge passage is arranged. The tapered second part B of the discharge passage is provided with the protruding structures, and the tapered second part B of the discharge passage is connected to the first part A of the discharge passage.

More preferably, as shown in FIG. 5, the protruding structures of the tapered second part B of the discharge passage constitute a corrugated structure. The discharge port left damping plate 25 is provided with a first corrugated surface, and the discharge port right damping plate 26 is provided with a second corrugated surface. The first corrugated surface and the second corrugated surface cooperate to constitute the corrugated structure.

When the mixture enters the tapered second part B from the first part A of the discharge passage, the cross-section of the mixture changes drastically when it passes through the corrugated structure, causing turbulence due to collision, which contributes to the generation of bubbles. When the mixture flows out of the second part B of the discharge passage, it is rapidly decompressed to an atmospheric pressure, and carbon dioxide rapidly evaporates from the mixture and agglomerates onto the bubble nuclei to form a polyurethane foam with uniform cells.

In addition, the feed pipe 22, the feed port left damping plate 23, the feed port right damping plate 24, the discharge port left damping plate 25, and the discharge port right damping plate 26 all have quick-release structures. When not in production, the first pouring mold 16 can be disassembled for cleaning, and can be quickly installed for pouring during production.

### Embodiment 3

Based on Embodiment 1 and Embodiment 2, the system in this embodiment also includes a first filter 14 and a pressure regulating device. The first filter 14 is arranged on the pipeline between the outlet of the stirring device 10 and the first pouring mold 16. The pressure regulating device includes a first pressure regulating valve 13 and a second pressure regulating valve 15. The first pressure regulating valve 13 is provided on the pipeline between the outlet of the stirring device 10 and the first filter 14. The second pressure regulating valve 15 is arranged on the pipeline between the first filter 14 and the first pouring mold 16. As shown in FIG. 1, the outlet of the stirring device 10 is connected to the first pressure regulating valve 13, the first filter 14, the second pressure regulating valve 15, and the first pouring mold 16 in sequence to constitute a pouring pipeline. After the mixture flows out through the first pressure regulating valve 13, it flows through the first filter 14 and the second pressure regulating valve 15 in turn and enters the first pouring mold 16, from which it is poured out to form a bulk polyurethane foam.

Among them, the first pressure regulating valve 13 can adjust the pressure of the mixture output by the stirring device 10, and control the pressure at 1-3 Mpa. It is preferable to adjust the pressure of the output mixture according to the different proportions of carbon dioxide in the formula, and control the pressure of the output mixture, so that the pressure of the output mixture is maintained at 1-3 Mpa to maintain the liquid state of the carbon dioxide.

The second pressure regulating valve 15 regulates the pressure of the mixture flowing through the first filter 14 to be 0.1-0.3 MPa lower than the pressure of the mixture in the stirring device 10. This pressure is very close to or slightly higher than the partial equilibrium pressure of the carbon dioxide dissolved in the final mixture. At this point, the carbon dioxide gas evaporated from the liquid carbon dioxide and the carbon dioxide gas generated by the reaction of the raw materials are evenly distributed in the mixture, and the bubbles agglomerate and grow. The mixture is cut and dispersed by a filter screen 21 to delay the generation of large bubbles, making the bubbles more uniform and smaller. Finally, after being sprayed from the first pouring mold 16, the pressure of the mixture is rapidly reduced to an atmospheric pressure, and carbon dioxide is rapidly evaporated and agglomerated onto the bubble nuclei to grow and form a polyurethane foam with uniform cells.

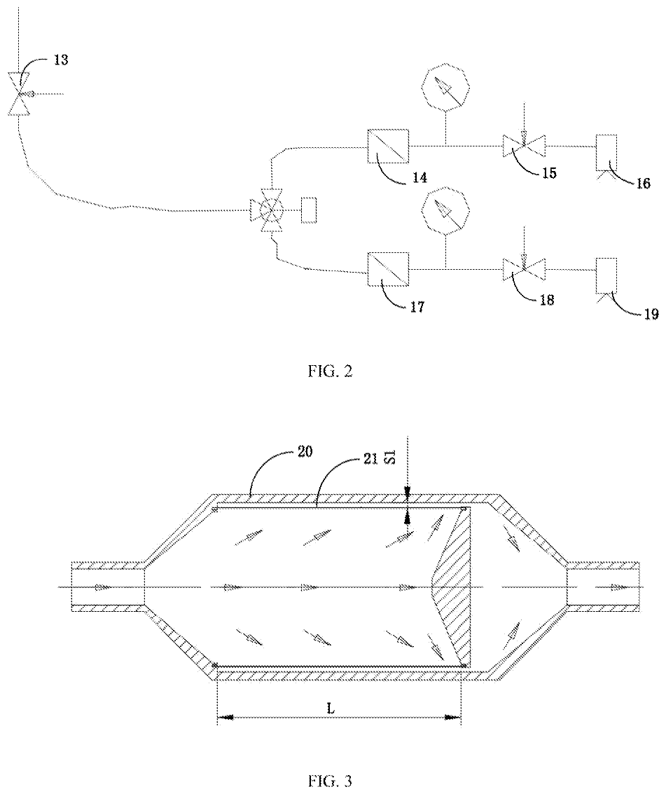

During actual uses, the first pouring mold 16 might occasionally be blocked. To reduce the loss caused by the blockage of the first pouring mold 16, as shown in FIG. 2, a backup pouring pipeline is added to the outlet of the first pressure regulating valve 13. A second pressure regulator 17, a third pressure regulating valve 18, and a second pouring mold 19 are installed in sequence on the backup pouring pipeline. Both pouring pipelines are equipped with pressure sensors to monitor the mixture pressure in real time. When the pressure in one of the working pipelines exceeds a set value, it can be switched to the backup pouring pipeline for production, and the blocked working pipeline can be manually disassembled, cleaned, and reinstalled to avoid downtime losses.

### Embodiment 4

Based on Embodiment 3, this embodiment provides a preferred implementation of the first filter 14. As shown in FIG. 3, the first filter 14 includes a filter housing 20 and a filter screen 21. The filter housing 20 is provided with an inlet section, an expanding section, a straight section, a contracting section, and an outlet section in sequence. The cross-sectional area of the inlet section is the same as the cross-sectional area of the outlet section and is smaller than the cross-sectional area of the straight section. The central axes of the inlet section, the expanding section, the straight section, the contracting section, and the outlet section are on the same straight line.

Since the cross-sectional area of the inlet section and the outlet section of the filter housing 20 is smaller than the cross-sectional area of the straight section, in coordination with the expanding section and the contracting section, the flow rate of the mixture in the filter housing 20 changes during the flow process. The central axes of the inlet section, the expanding section, the straight section, the contracting section, and the outlet section are on the same straight line, so that eddy currents in the filter housing 20 are reduced, thereby reducing the flow resistance.

As shown in FIG. 3, the filter screen 21 has a U-shaped longitudinal-section and is detachably arranged in the straight section inside the filter housing 20. There is a set gap between the outer wall of the filter screen 21 and the inner wall of the filter housing 20 to form a filter flow cavity. The width of the filter flow cavity is S1 and the length is L. When S1 is determined, by reasonably adjusting the opening ratio of the filter screen 21 and the length L of the filter flow cavity, the ratio of the filter area to the flow area of the inlet section can be configured between 3 and 5 times, which not only meets the filter flow requirements, but also maintains a flow speed of the mixture flowing through the filter screen 21, that have cutting effects on the mixture to generate microbubbles.

In addition, the filter screen 21 is arranged in a U shape in the filter cylinder, so that the filtering area of the filter screen 21 is much larger than the cross-sectional area of the inlet section of the filter housing 20. Combined with the above-mentioned structure of the filter housing, the flow rate of the mixture passing through the filter screen 21 is relatively uniform, which greatly improves the filtration effect.

### Embodiment 5

Based on the above embodiments, as shown in FIG. 1, in this embodiment, the liquid carbon dioxide high-pressure supply unit 3, the polyol high-pressure supply unit 1, the additive high-pressure supply unit 5, the isocyanate high-pressure supply unit 12, the chemical reagent high-pressure supply unit 8, and the auxiliary high-pressure supply unit 9 are respectively provided with feed storage tanks and self-circulating exhaust pipelines connected to each feed storage tank. Each self-circulating exhaust pipeline is equipped with a metering device and a measuring device. The metering device includes a metering pump and a mass flow meter connected in sequence. The measuring device includes a pressure sensor and a temperature sensor. As shown in FIG. 1, before the production process starts, and before the above-mentioned supply units introduce the raw materials into the stirring device 10, a self-circulating exhaust process is carried out. According to the formula, various raw materials that need to be added are first pumped out from their respective supply storage tanks by the metering pumps. The various raw materials are circulated back to the supply storage tanks through the self-circulating exhaust pipeline. This cycle is to eliminate the air existing in the pipeline and to facilitate accurate measurement of the amount of each raw material. The outlets of the self-circulating exhaust pipelines and the feed ports of the stirring device 10 are connected through three-way valves. There are also sequentially connected one-way valves and nozzles on the pipelines between the outlet of the self-circulating exhaust pipelines and the feed ports of the stirring device 10. When the production process starts, the three-way valves are switched, and various raw materials that have been metered in the circulation exhaust pipelines pass through the three-way valves and the one-way valves. Finally, the high-pressure raw materials are injected into the stirring device 10 through the nozzles.

In this embodiment, the nucleation gas supply unit 7 preferably uses high-pressure nitrogen as the nucleation gas, and the high-pressure nitrogen is stored in a grouped gas cylinder.

Since liquid carbon dioxide requires low-temperature and high-pressure storage (−18° C. to −24° C., 1.85 Mpa) to maintain a liquid state, the liquid carbon dioxide circulation pipeline is switched on before the start of production, which drains the gas in the pipeline and cools all pipes and fittings to prevent carbon dioxide from evaporating.

Therefore, in this embodiment, the liquid carbon dioxide circulation pipeline is preferably provided with an internal circulation cooling pipeline and an external circulation cooling pipeline. As shown in FIG. 1, the outlet and inlet of the liquid carbon dioxide storage tank are connected through pipelines to form an internal circulation cooling pipeline. The outlet of the liquid carbon dioxide storage tank, the liquid carbon dioxide pressure sensor, the liquid carbon dioxide metering pump, the liquid carbon dioxide mass flow meters, and the inlet of the liquid carbon dioxide storage tank are connected in sequence through pipelines to form an external circulation cooling pipeline. First, the internal circulation cooling pipeline is switched on some time before the start of the production, preferably 40 minutes before the start of the production. The transfer pump provided on the outlet pipeline of the liquid carbon dioxide storage tank pumps the liquid carbon dioxide into the internal circulation cooling pipeline, and then return it to the liquid carbon dioxide storage tank, so that the supply pipes outside the liquid carbon dioxide storage tank can reach the liquid carbon dioxide storage temperature range (−18° C. to −24° C.), eliminating the possibility of liquid carbon dioxide evaporation due to temperature rise. When the internal circulation cooling process exceeds 30 minutes, the internal circulation cooling pipeline is switched off and the external circulation cooling pipeline is switched on. When the temperature in the external circulation cooling pipeline reaches the storage temperature range of liquid carbon dioxide, the liquid carbon dioxide is introduced into the stirring device 10 according to the formula dosage, to be mixed with other ingredients.

### Embodiment 6

Based on Embodiment 5, when producing polyurethane sponge, multiple polyol high-pressure supply units 1 and additive high-pressure supply units 5 can be set up according to the formula requirements, and the outlets of the polyol high-pressure supply units 1 are gathered at a second high-pressure manifold 2. The outlets of multiple additive high-pressure supply units 5 are gathered at a first high-pressure manifold 6. Each polyol high-pressure supply unit 1 includes a self-circulating exhaust pipeline. When the formula requires the deployment of the corresponding polyol high-pressure supply units 1, the corresponding self-circulation exhaust pipelines are switched on. After the exhaust process is completed, the several metered polyol compounds are introduced into the first high-pressure manifold 2 and mixed evenly to form a first mixture. At the same time, the outlet of the second high-pressure manifold 2 and the outlet of the liquid carbon dioxide high-pressure supply unit 3 are gathered at a static mixer 4, and the metered liquid carbon dioxide and the first mixture are evenly mixed in the static mixer 4 to form a second mixture. The outlet of the static mixer 4 and the outlet of the additive high-pressure supply unit 5 are brought together through inlets of the first high-pressure manifold 6. The second mixture and various additives are uniformly mixed in the first high-pressure manifold 6 to form a third mixture. The outlet of the first high-pressure manifold 6 is connected to a feed port of the stirring device 10. The outlet of the nucleation gas supply unit 7 is connected to the outlet of the first high-pressure manifold 6. And the nucleation gas (high-pressure nitrogen) is injected into the third mixture before it flows from the first high-pressure manifold 6 into the stirring device 10, to form a fourth mixture. And then the fourth mixture is injected into the stirring device 10 to be stirred and mixed with the other raw materials to form the final mixture.

In the actual production, one or more isocyanate raw materials can be chosen for the isocyanate high-pressure supply unit 12 according to the formula. Correspondingly, multiple isocyanate high-pressure supply units 12 can be provided. The isocyanate raw material is preferably TDI. When multiple isocyanate raw materials are used in the production, the outlets of the isocyanate high-pressure supply units 12 are gathered at a third high-pressure manifold. The multiple isocyanate raw materials are uniformly mixed in the third high-pressure manifold and then are divided into two pipelines and injected into the stirring device 10.

The chemical reagent of the chemical reagent high-pressure supply unit 8 is preferably water, and the auxiliary agent of the auxiliary high-pressure supply unit 9 is preferably tin.

The order in which the above-mentioned raw materials are injected into the stirring device 10 is preferably the fourth mixture, isocyanates, chemical reagents, and auxiliary agents. The injection order can also be adjusted according to the raw materials chosen in the formula and the reaction time of the raw materials.

Preferably, the supply system is also equipped with one or more additional raw material high-pressure supply units 11. The outlets of the additional raw material high-pressure supply units 11 are connected to feed ports of the stirring device 10, and can be used as backup raw material supply units, or other raw materials can be added according to the production formula.

The mixing speed of the stirring device 10 is 1000-6000 RPM, and the mixing speed can be adjusted according to the formula.

The above are only the preferred embodiments of the present application. It should be pointed out, that for those of ordinary skill in the art, several improvements and modifications can be made without departing from the principles of the present application. These improvements and modifications should also be regarded as within the protection scope of the present application.

1. A polyurethane sponge stepwise decompression production system using liquid carbon dioxide as a foaming agent, characterized by comprising a supply system, a stirring device, and a pouring system; wherein,
the supply system includes a liquid carbon dioxide high-pressure supply unit, and an outlet of the liquid carbon dioxide high-pressure supply unit is connected to a feed port of the stirring device, and the stirring device is used to uniformly mix raw materials under high pressure to obtain a mixture, wherein the raw materials include liquid carbon dioxide; and,
an outlet of the stirring device is connected to the pouring system, whereby the mixture is decompressed through the outlet of the stirring device to a pressure slightly higher than a saturated vapor pressure of the liquid carbon dioxide and transported to the pouring system, and the mixture is sprayed from the pouring system, whereby the mixture is reduced to an atmospheric pressure and foams into a polyurethane sponge.

2. The polyurethane sponge stepwise decompression production system according to claim 1, characterized in that,
the pouring system includes a pouring mold, and the pouring mold includes a discharge passage, wherein the discharge passage is provided with protruding structures, and the protruding structures are used to facilitate a turbulence of the mixture and forming of bubbles when sprayed through the discharge passage.

3. The polyurethane sponge stepwise decompression production system according to claim 1, further comprising:
a filter, provided on a pipeline between the outlet of the stirring device and the pouring system, and used for filtering and cutting the mixture to generate microbubbles.

4. The polyurethane sponge stepwise decompression production system according to claim 3, further comprising:
a pressure regulating device, wherein the pressure regulating device includes a first pressure regulating valve and a second pressure regulating valve, and the first pressure regulating valve is arranged at the pipeline between the outlet of the stirring device and the filter, to maintain the mixture at a pressure slightly above the partial pressure of the carbon dioxide to slow down the vaporization of the carbon dioxide; and,
the second pressure regulating valve is provided at the pipeline between the filter and the pouring system, to reduce the pressure of the mixture to accelerate the vaporization of the carbon dioxide.

5. The polyurethane sponge stepwise decompression production system according to claim 1, characterized in that,
the supply system further includes a polyol high-pressure supply unit, an additive high-pressure supply unit, an isocyanate high-pressure supply unit, a chemical reagent high-pressure supply unit, an auxiliary high-pressure supply unit, and a nucleation gas supply unit, that are respectively connected to feed ports of the stirring device.

6. The polyurethane sponge stepwise decompression production system according to claim 5, characterized in that,
an outlet of the polyol high-pressure supply unit and the outlet of the liquid carbon dioxide high-pressure supply unit are liquidly connected to a static mixer, and the static mixer is used to uniformly mix polyol and the liquid carbon dioxide to form an initial mixture; and,
an outlet of the static mixer and an outlet of the additive high-pressure supply unit are brought together at a first high-pressure manifold to uniformly mix additives and the initial mixture to form an intermediate mixture, and an outlet of the first high-pressure manifold is connected to a feed port of the stirring device; and,
an outlet of the nucleation gas supply unit is connected to the outlet of the first high-pressure manifold, to inject nucleation gas into the intermediate mixture before entering the stirring device.

7. The polyurethane sponge stepwise decompression production system according to claim 2, characterized in that,
the pouring mold includes a feed pipe, a feed port left damping plate, a feed port right damping plate, a discharge port left damping plate, and a discharge port right damping plate; and,
the feed port left damping plate is provided with a feed channel, and the feed port right damping plate is provided with a storage channel, and the feed channel and the storage channel together constitute a storage space, and a first part of the discharge passage is provided below the storage space; and,
the discharge port left damping plate is arranged below the feed port left damping plate, and the discharge port right damping plate is arranged below the feed port right damping plate, and a tapered second part of the discharge passage is provided between the discharge port left damping plate and the discharge port right damping plate, and the tapered second part of the discharge passage is provided with the protruding structures, and the tapered second part of the discharge passage is connected to the first part of the discharge passage.

8. The polyurethane sponge stepwise decompression production system according to claim 7, characterized in that,
the protruding structures constitute a corrugated structure, and the discharge port left damping plate is provided with a first corrugated surface, and the discharge port right damping plate is provided with a second corrugated surface, whereby the first corrugated surface and the second corrugated surface cooperate to constitute the corrugated structure.

9. The polyurethane sponge stepwise decompression production system according to claim 3, characterized in that,
the filter includes a filter housing and a filter screen, wherein the filter housing has an inlet section, an expanding section, a straight section, a contracting section and an outlet section, and a cross-sectional area of the inlet section has a same size as a cross-sectional area of the outlet section and is smaller than a cross-sectional area of the straight line section, and central axes of the inlet section, the expanding section, the straight section, the contracting section and the outlet section are on a same straight line; and,
the filter screen has a U-shaped longitudinal section and is detachably installed inside the filter housing, and a set gap is arranged between an outer wall of the filter screen and an inner wall of the filter housing, and the set gap constitutes a filter flow cavity.

10. The polyurethane sponge stepwise decompression production system according to claim 5, characterized in that,
the liquid carbon dioxide high-pressure supply unit, the polyol high-pressure supply unit, the additive high-pressure supply unit, the isocyanate high-pressure supply unit, the chemical reagent high-pressure supply unit and the auxiliary high-pressure supply unit are respectively provided with feed storage tanks and self-circulating exhaust pipelines, wherein the self-circulating exhaust pipelines are respectively connected to each of the feed storage tanks, and are used to discharge gas in pipelines for accurate measurement of dosages; and,
the supply system further includes metering devices and measuring devices respectively provided on each of the self-circulating exhaust pipelines.
